(19) United States
(12) Patent Application Publication
(10) Pub. No.: US 2024/0084555 A1
(43) Pub. Date: Mar. 14, 2024

(54) CONSTRUCTION MACHINE WITH A HYDRAULIC SYSTEM

(71) Applicant: XCMG European Reseach Center GmbH, Krefeld (DE)

(72) Inventors: Martin INDERELST, Duisburg (DE); Stefan POLLMEIER, Köln (DE)

(21) Appl. No.: 18/242,108

(22) Filed: Sep. 5, 2023

(30) Foreign Application Priority Data
Sep. 8, 2022 (EP) 22194607.2

(51) Int. Cl. E02F 9/22

(52) U.S. Cl. CPC E02F 9/2285; E02F 9/2228; E02F 3/42

(57) ABSTRACT

A construction machine with a hydraulic system has a hydraulic control, which comprises a joystick, a hydraulic pressure source, and two hydraulic drives. Main control valves are controlled by a joystick. The construction machine comprises multiple components, and a hydraulic drive is assigned for moving these components.

The hydraulic control comprises an electrically-actuatable priority proportional valve in the hydraulic connection of a drive. The priority valve is electrically connected to the electronic control unit and generates additional hydraulic resistance. The hydraulic control comprises sensors, on the components, for detection of the positions thereof. The detected sensor values are transferred to the control unit. At least one trajectory is stored in the control unit. A control mode can be activated, in which each priority valve is controlled using the current sensor values upon actuation of the joystick so that the stored trajectory is run by control of the drives.

### CROSS-REFERENCE TO RELATED APPLICATIONS AND CLAIM TO PRIORITY

This application is related to application number 22194607.2, filed Sep. 8, 2022, in the European Patent Office, the disclosure of which is incorporated herein by reference and to which priority is claimed.

### FILED OF THE INVENTION

The invention relates to a construction machine with a hydraulic system with at least one hydraulic control, which comprises at least one joystick, at least one hydraulic pressure source, and two hydraulic drives, wherein the pressure level of each hydraulic drive can be different depending on the working point of the drive selected in each case, wherein each hydraulic drive is connected to each pressure source by means of one hydraulic connection each, in which in each case a main control valve is provided, which can be controlled by the one joystick or at least one of the joysticks, wherein the construction machine comprises multiple components that can move at least relative to one another, to which in each case a hydraulic drive for moving these components is assigned.

Such construction machines are known from experience in various implementations. In this case, it is disadvantageous that when such construction machines are in actual use, recurring working processes also occur that are difficult to reproduce with precision under manual control, so that deviations from the desired working processes are unavoidable and can lead to a poor or even unsatisfactory working result.

### SUMMARY OF THE INVENTION

The object of the invention is to avoid the above-mentioned drawbacks and to indicate an improved construction machine, with which an improved option for implementing working processes, in particular recurring working processes, is provided.

This object is achieved in the case of a generic construction machine, in that at least one hydraulic control comprises at least one priority valve that is designed to be electrically actuatable and that is designed as a proportional valve, which priority valve is assigned to a drive and is provided in its hydraulic connection, wherein each priority valve is electrically connected to the electronic control unit and can be controlled to generate additional hydraulic resistance, wherein the hydraulic control additionally comprises sensors that are provided on the movable components for indirect or direct detection of the respective positions thereof, which are in each case connected to the latter in order to transfer the detected sensor values to the control unit, wherein in addition, in the control unit, on the one hand, at least one trajectory can be stored, and, on the other hand, a control mode can be activated, in which each priority valve can be controlled using the values actually detected in each case by the sensors upon actuation of the at least one joystick by the control unit in such a way that the stored trajectory is run by corresponding control of the drives.

Thus, when activating the control mode, at least one priority valve is actuated depending on the requirement for achieving the stored trajectory, so that either the hydraulic drive with the higher load is prioritized over the hydraulic drive with the lower load, or conversely, the hydraulic drive with the smaller load is prioritized over the hydraulic drive with the higher load. Consequently, the drive with the lower load is loaded with more resistance, so that it is in effect actuated less than it is actually preset by the operator of the construction machine by his actuation of the joystick.

Thus, it is possible to control the speed and position of the hydraulic drive by the priority valve(s), since in this way, in each case the respective hydraulic resistance in a hydraulic connection is changed and thus the hydraulic flow to the respective drive is altered with respect to the specification of the joystick. Thus, in the case of an activated control mode with any actuation of the joystick, the trajectory stored in the control unit can be automatically travelled as long as the joystick continues to be actuated.

Preferably, at least two hydraulic pressure sources can be provided, wherein each hydraulic drive is connected to each pressure source by means of one hydraulic connection each, and at least two hydraulic pressure sources have different pressure levels.

According to the invention, in the case of at least one hydraulic control, the priority valve in the corresponding hydraulic connection or the priority valves in the corresponding hydraulic connections can in each case be arranged between the corresponding hydraulic pressure source and the associated main control valve, so that the respective priority valve, viewed from the pressure source, is provided in front of the corresponding main control valve.

The main control valves are provided in each case in the connection of a single pressure source with a single hydraulic drive. In this case, first a branch can be provided to each pressure source, starting from which two separate connections within each case a main control valve can then lead to the two hydraulic drives. The priority valve or the priority valves is/are in this case preferably provided in each case between the branch and the corresponding respective main control valve.

When two priority valves are provided, in each case one of the two separate connections can then be equipped with a priority valve from each pressure source behind the branch and can lead to a drive, whereas the other one of the two separate connections is not equipped with a priority valve and leads to the other drive. In this case, the two separate connections of the two pressure sources, which in each case are equipped with a priority valve, can either lead to the same drive or else in each case can lead to different drives.

Advantageously, in the case of at least one hydraulic control, on the one hand, at least one main control valve can be designed as a hydraulically-controlled main control valve, preferably every main control valve can be designed as a hydraulically-controlled main control valve, and, on the other hand, the corresponding joystick provided for the hydraulic control can be designed as an at least partially hydraulic joystick, preferably as a fully hydraulic joystick, with which at least one of the existing hydraulically-controlled main control valves, preferably every hydraulically-controlled main control valve, can be controlled. Thus, control of the main control valves relative to a hydraulic circuit can also be exercised with an electric joystick and electrically-actuated main control valves even when the electrical components fail.

Preferably, in the case of at least one hydraulic control, at least one electrical movement sensor can be assigned to each hydraulic drive for detecting movements of the relevant hydraulic drive, so that in real time, a corresponding control and also regulation of the priority valves corresponding to the respective movement of the relevant hydraulic drive that can also be dependent upon external circumstances, such as, e.g., load, resistances, etc., is possible.

In this respect, in the case of at least one hydraulic control, at least one electrical movement sensor can also be assigned to each hydraulic drive for detecting movements of the relevant component that can be moved by the respective hydraulic drive.

Alternatively or additionally, in the case of at least one hydraulic control, at least one sensor can also be designed for detecting the position of a movable component of the construction machine for the indirect or direct detection of the absolute position in space.

In addition, in the case of at least one hydraulic control, at least one sensor for detecting the position of a movable component of the construction machine can be designed for the detection of the relative position of this component relative to the construction machine and/or another component of the construction machine.

Also, in the case of at least one hydraulic control, in each case a pressure sensor connected to the control unit can be assigned to at least one hydraulic drive, preferably every hydraulic drive, which pressure sensor detects the hydraulic pressure acting on this hydraulic drive and passes it on to the control unit.

In the case of a preferred embodiment of the invention, in the case of at least one hydraulic control, at least one main control valve can be designed as an electrically-controlled main control valve, preferably every main control valve can be designed in each case as an electrically-controlled main control valve, wherein at least one joystick is designed as an at least partially electric, preferably as a fully electric, joystick, for controlling at least one, preferably every, existing electrically-controlled main control valve.

Advantageously, in the case of at least one hydraulic connection, the latter can be formed in the partial area behind the main control valve by two partial connections in order thus to be able to produce different movement directions of the drive.

According to the invention, the construction machine can be designed as a hydraulic excavator and can comprise an undercarriage, a rotating superstructure arranged thereon, and an extension arm arranged to be able to pivot on the superstructure.

In this case, the extension arm can be designed as an articulated arm with a first arm segment arranged to be able to pivot on the superstructure and with a second arm segment arranged to be able to pivot on the first arm segment, wherein a bucket can be arranged to be able to pivot on the second arm segment.

Advantageously, the construction machine can be designed so that in the case of at least one hydraulic control, the two drives can produce maximum forces of different levels, and the hydraulic drive with the higher maximum force is assigned to the first arm segment for its pivoting, wherein the hydraulic drive with the lower maximum force is assigned to the second arm segment for its pivoting relative to the first arm segment.

Preferably, in the case of at least one hydraulic control, at least one hydraulic drive can be designed as at least one hydraulic cylinder, preferably as multiple hydraulic cylinders provided in parallel; preferably every hydraulic drive can be designed in each case as at least one hydraulic cylinder, preferably as multiple hydraulic cylinders provided in parallel.

Furthermore, in the case of at least one hydraulic control, the control mode can be activated at least manually.

In addition, in the case of at least one hydraulic control, sensor values, for example in the form of a sensor value combination and/or a sensor value sequence, can be stored in the control unit, in which the control mode is to be activated, and an algorithm for evaluating the sensor values currently detected by the sensors, and, in the event that they accordingly match the sensor values stored in the control unit, and/or sensor value combination(s) and/or sensor value sequence(s), automatic activation of the control mode can be integrated into the control unit.

According to the invention, in the case of at least one hydraulic control, an automatic mode can be activated in the control unit, in which automatic mode the algorithm for automatic activation of the control mode is active.

### BRIEF DESCRIPTION OF THE DRAWINGS

Below, embodiments of the invention depicted in the drawings are explained. Here:

FIG. 1 shows a first embodiment of a construction machine according to the invention,

FIG. 2 shows a second embodiment of a construction machine according to the invention, and

FIG. 3 shows a third embodiment of a construction machine according to the invention.

In all figures, identical reference symbols are used for the same or similar components.

### DETAILED DESCRIPTION OF THE PREFERRED EMBODIMENT(S)

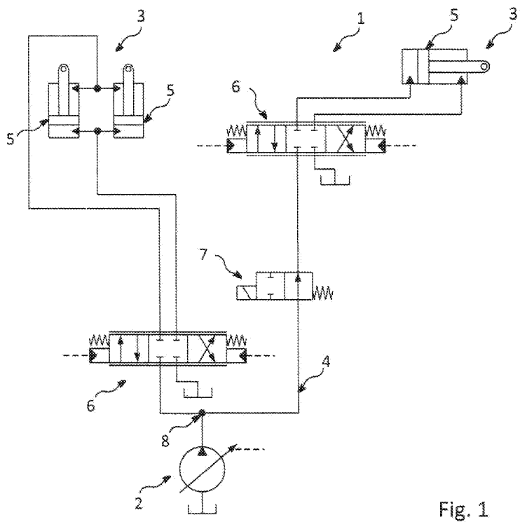

FIG. 1 relates to a construction machine, not depicted in the drawing, with a hydraulic system with a hydraulic control 1, which comprises a joystick, not depicted in the drawing, a hydraulic pressure source 2, and two hydraulic drives 3, which are provided for moving at least components of the construction machine that can move relative to one another and in this respect are assigned in each case to such a component.

Each hydraulic drive 3 is connected to the pressure source 2 by means of one hydraulic connection 4 each. In each of these hydraulic connections 4, in each case a main control valve 6 is provided, which can be controlled by the joystick. The hydraulic drives 3 shown are designed either as an individual hydraulic cylinder 5 or as two hydraulic cylinders 5 that are provided in parallel.

In addition, a priority valve 7 is comprised that can be actuated electrically and that is designed as a proportional valve. The priority valve 7 is assigned to one of the two drives 3 and is provided in its hydraulic connection 4, namely in each case between the hydraulic pressure source 2 and the associated main control valve 6, so that the priority valve 7, viewed from the pressure source 2, is provided in front of the corresponding main control valve 6. In the example shown in FIG. 1, the priority valve 7 is assigned to the drive 3 that is designed as an individual hydraulic cylinder 5.

The main control valves 6 are in each case provided in the connection 4 of the pressure source 2 with a single hydraulic drive 3. If—as shown in FIG. 1—first a branch 8 is provided in the case of the pressure source 2, two separate connections 4 with in each case a main control valve 6 then drain to one each of the two hydraulic drives 3. The priority valve 7 is in this case provided between the branch 8 and the corresponding main control valve 6.

In the hydraulic control 1 shown, all main control valves 6 are designed in each case as hydraulically-controlled main control valves 6, which can be controlled by the joystick designed as an at least partially hydraulic joystick, preferably fully hydraulic joystick. Thus, the control of the main control valves 6 is also possible in addition when the electrical components fail.

The priority valve 7 is electrically connected to an electronic control unit, not depicted in the drawing, and can be controlled by this control unit to generate additional hydraulic resistance.

In addition, the hydraulic control 1 comprises sensors, not depicted in the drawing and provided on the movable components, for indirect or direct detection of their respective position, which, to transfer the detected sensor values to the control unit, are in each case connected to the latter. In the control unit, on the one hand, at least one trajectory can be stored and, on the other hand, a control mode can be activated, in which the priority valve 7 can be controlled using the values currently detected in each case by the sensors when the joystick is actuated by the control unit, in such a way that the stored trajectory is run by corresponding control of the drives 3.

Thus, in the case of the activation of the control mode, the priority valve 7 is actuated depending on the requirement for reaching the stored trajectory, so that either the hydraulic drive 3 with the higher load is prioritized over the hydraulic drive 3 with the lower load, or conversely, the hydraulic drive 3 with the lower load is prioritized over the hydraulic drive 3 with the higher load. Consequently, the drive 3 with the lower load is loaded with more resistance, so that it is in effect actuated less than it is actually preset by the operator of the construction machine by his actuation of the joystick.

Thus, it is possible to control the speed and position of the hydraulic drive 3 by the priority valve 7, since the latter changes the hydraulic resistance in the hydraulic connections 4 and thus the hydraulic flow to the respective drive 3 is altered with respect to the specification of the joystick. Thus, in the case of an activated control mode with any actuation of the joystick, the trajectory stored in the control unit can be automatically travelled as long as the joystick continues to be actuated.

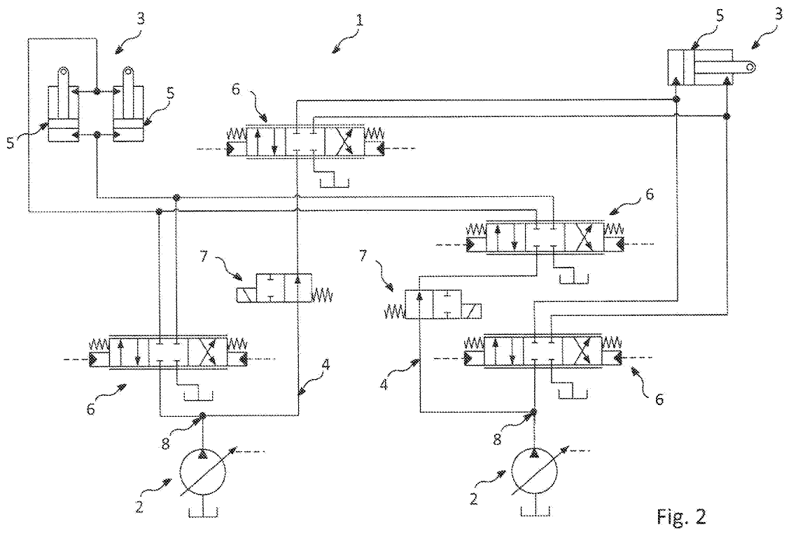

In FIG. 2, a second embodiment of the invention is shown. There, deviating from the object shown in FIG. 1, two hydraulic pressure sources 2 with different pressure levels are provided. Each hydraulic drive 3 is connected to two pressure sources 2 by means of one hydraulic connection 4 each, in which in each case a main control valve 6 that can be controlled by the joystick is provided.

Also, in the case of this embodiment, two priority valves 7 that can be actuated electrically and that are designed as proportional valves are comprised, which both are assigned to one of the two drives 3 and in which both hydraulic connections 4 are provided. The two priority valves 7 are in each case arranged between the corresponding hydraulic pressure source 2 and the associated main control valve 6, so that the respective priority valve 7, viewed from the pressure source 2, is provided in front of the corresponding main control valve 6, specifically between the branch 8 and the corresponding respective main control valve 6. In this case, first a branch 8 is provided to each pressure source 2, starting from which in each case two separate connections 4 with in each case a main control valve 6 then lead to one each of the two hydraulic drives 3.

The priority valves 7 are in each case electrically connected to an electronic control unit, not depicted in the drawing, and they can be controlled by this control unit to generate additional hydraulic resistance.

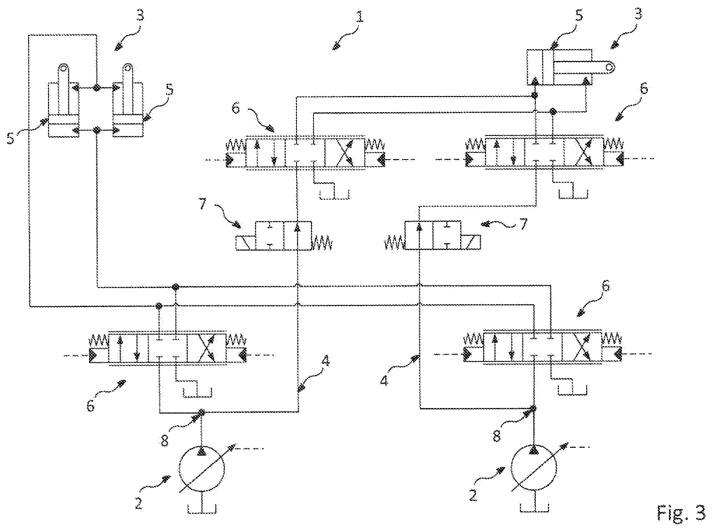

However, in the embodiment shown in FIG. 3, namely also two hydraulic pressure sources 2 with different pressure levels as well as two priority valves 7 that are designed to be electrically actuatable and that are designed as proportional valves are comprised. As an alternative to the object shown in FIG. 3, the two priority valves 7 are assigned, however, to a single one of the two drives 3 and are provided in its two hydraulic connections 4.

In this case, they are arranged in each case between the corresponding hydraulic pressure source 2 and the associated main control valve 6, so that the respective priority valve 7 viewed from the pressure source 2 is provided in front of the corresponding main control valve 6. In the example shown in FIG. 3, the two priority valves 7 are assigned to the drive 3 that is designed as an individual hydraulic cylinder 5.

The main control valves 6 are in each case provided in the connection 4 of a single pressure source 2 with a single hydraulic drive 3. If—as shown in FIG. 3—each pressure source 2 is first provided with a branch 8, then in each case, two separate connections 4 with in each case a main control valve 6 drain to one each of the two hydraulic drives 3.

The priority valves 7 are in this case provided in each case between the branch 8 and the corresponding respective main control valve 6.

In the case of the hydraulic control 1 shown, all main control valves 6 in each case are designed as a hydraulically-controlled main control valve 6, which can be controlled by the at least partially hydraulic joystick, preferably fully hydraulic joystick. Thus, control of the main control valves is also possible in addition even when the electrical components fail.

The priority valves 7 are in each case electrically connected to an electronic control unit, not depicted in the drawing, and they can be controlled by this control unit to generate additional hydraulic resistance.

In addition, the hydraulic control 1 comprises sensors provided on the movable components for indirect or direct detection of these respective positions, which are in each case connected to the latter in order to transfer the detected sensor values to the control unit. In the control unit, on the one hand, at least one trajectory can be stored, and, on the other hand, a control mode can be activated, in which the priority valves 7 can be controlled using the values actually detected in each case by the sensors upon actuation of the joystick by the control unit in such a way that the stored trajectory is run by corresponding control of the drives 3.

Thus, in the case of the activation of the control mode, the priority valves 7 are actuated depending on the requirement for reaching the stored trajectory, so that either the hydraulic drive 3 with the higher load is prioritized over the hydraulic drive 3 with the lower load, or conversely, the hydraulic drive 3 with the lower load is prioritized over the hydraulic drive 3 with the higher load. Consequently, the drive 3 with the lower load is loaded with more resistance, so that it is in effect actuated less than it is actually preset by the operator of the construction machine by his actuation of the joystick.

Thus, it is possible to control the speed and position of the hydraulic drive 3 by the priority valves 7, since the latter change the respective hydraulic resistance in the hydraulic connections 4 and thus the hydraulic flow to the respective drives 3 is altered with respect to the specification of the joystick. Thus, in the case of an activated control mode with any actuation of the joystick, the trajectory stored in the control unit can be automatically travelled as long as the joystick continues to be actuated.

We claim:

1. Construction machine with a hydraulic system with at least one hydraulic control (1), which comprises at least one joystick, at least one hydraulic pressure source (2), and two hydraulic drives (3), wherein the pressure level of each hydraulic drive (3) can be different depending on the working point of the drive (3) selected in each case, wherein each hydraulic drive (3) is connected to each pressure source (2) by means of one hydraulic connection (4) each, in which in each case, a main control valve (6) is provided, which can be controlled by the one joystick or at least one of the joysticks, wherein the construction machine comprises multiple components that can move at least relative to one another, to which components in each case a hydraulic drive (3) for moving this component is assigned, wherein at least one hydraulic control (1) comprises at least one priority valve (7) that is designed to be electrically actuatable and that is designed as a proportional valve, which is assigned to a drive (3) and is provided in its hydraulic connection (4), wherein each priority valve (7) is electrically connected to the electronic control unit and can be controlled to generate additional hydraulic resistance, wherein the hydraulic control (1) additionally comprises sensors, provided on the movable components, for indirect or direct detection of the respective positions thereof, which are in each case connected to the latter in order to transfer the detected sensor values to the control unit, wherein in addition, in the control unit, on the one hand, at least one trajectory can be stored, and, on the other hand, a control mode can be activated, in which each priority valve (7) can be controlled using the values actually detected in each case by the sensors upon actuation of the at least one joystick by the control unit in such a way that the stored trajectory is run by corresponding control of the drives (3).

2. Construction machine according to claim 1, wherein the at least two hydraulic pressure sources (2) are provided, wherein each hydraulic drive (3) is connected to each pressure source (2) by means of one hydraulic connection (4) each, and at least two hydraulic pressure sources (2) have different pressure levels.

3. Construction machine according to claim 1, wherein in the case of at least one hydraulic control (1), the priority valve (7) in the corresponding hydraulic connection (4) or the priority valves (7) in the corresponding hydraulic connections (4) is/are arranged in each case between the corresponding hydraulic pressure source (2) and the associated main control valve (6).

4. Construction machine according to claim 1, wherein in the case of at least one hydraulic control (1), on the one hand, at least one main control valve (6) is designed as a hydraulically-controlled main control valve (6), preferably every main control valve (6) is designed as a hydraulically-controlled main control valve (6), and, on the other hand, each corresponding joystick provided for the hydraulic control is designed as an at least partially hydraulic joystick, preferably as a fully hydraulic joystick, with which in each case at least one of the existing hydraulically-controlled main control valves (6), preferably every hydraulically-controlled main control valve (6), can be controlled.

5. Construction machine according to claim 1, wherein in the case of at least one hydraulic control (1), at least one electrical movement sensor is assigned to each hydraulic drive (3) for detecting movements of the relevant hydraulic drive (3).

6. Construction machine according to claim 1, wherein in the case of at least one hydraulic control (1), at least one electrical movement sensor is assigned to each hydraulic drive (3) for detecting movements of the relevant component that can be moved by the respective hydraulic drive (3).

7. Construction machine according to claim 1, wherein in the case of at least one hydraulic control (1), at least one sensor is designed for detecting the position of a movable component of the construction machine for the indirect or direct detection of the absolute position in space.

8. Construction machine according to claim 1, wherein in the case of at least one hydraulic control (1), at least one sensor for detecting the position of a movable component of the construction machine is designed for detecting the relative position of this component with reference to the construction machine and/or another component of the construction machine.

9. Construction machine according to claim 1, wherein in the case of at least one hydraulic control (1), in each case a pressure sensor connected to the control unit is assigned to at least one hydraulic drive (3), preferably each hydraulic drive (3), which pressure sensor detects the hydraulic pressure acting on this hydraulic drive (3) and passes it on to the control unit.

10. Construction machine according to claim 1, wherein in the case of at least one hydraulic control (1), at least one main control valve (6) is designed as an electrically-controlled main control valve (6), preferably every main control valve (6) in each case is designed as an electrically-controlled main control valve (6), wherein at least one joystick is designed as an at least partially electric, preferably as a fully electric, joystick, for controlling at least one, preferably every, existing electrically-controlled main control valve (6).

11. Construction machine according to claim 1, wherein in the case of at least one hydraulic connection (4), the latter is formed in the partial area behind the main control valve (6) by two partial connections.

12. Construction machine according to claim 1, wherein the construction machine is designed as a hydraulic excavator and comprises an undercarriage, a rotating superstructure arranged thereon, and an extension arm arranged to be able to pivot on the superstructure.

13. Construction machine according to claim 12, wherein the extension arm is designed as an articulated arm with a first arm segment arranged to be able to pivot on the superstructure and with a second arm segment arranged to be able to pivot on the first arm segment, wherein a bucket can be arranged to be able to pivot on the second arm segment.

14. Construction machine according to claim 13, wherein in the case of at least one hydraulic control (1), the two drives (3) can produce maximum forces of different levels, and the hydraulic drive (3) with the higher maximum force is assigned to the first arm segment for its pivoting, wherein the hydraulic drive (3) with the lower maximum force is assigned to the second arm segment for its pivoting relative to the first arm segment.

15. Construction machine according to claim 1, wherein in the case of at least one hydraulic control (1), at least one hydraulic drive (3) is designed as at least one hydraulic cylinder (5), preferably as multiple hydraulic cylinders (5) provided in parallel; preferably every hydraulic drive (3) is designed in each case as at least one hydraulic cylinder (5), preferably as multiple hydraulic cylinders (5) provided in parallel.

16. Construction machine according to claim 1, wherein in the case of at least one hydraulic control (1), the control mode can be activated at least manually.

17. Construction machine according to claim 1, wherein in the case of at least one hydraulic control (1), sensor values, for example in the form of a sensor value combination and/or a sensor value sequence, are stored in the control unit, in which the control mode is to be activated, and an algorithm for evaluating the sensor values currently detected by the sensors, and, in the event that they accordingly match the sensor values stored in the control unit, and/or sensor value combination(s) and/or sensor value sequence(s), automatic activation of the control mode is integrated into the control unit.

18. Construction machine according to claim 17, wherein in the case of at least one hydraulic control (1), an automatic mode can be activated in the control unit, in which automatic mode the algorithm for automatic activation of the control mode is active.

19. Construction machine according to claim 1, wherein in the case of at least one hydraulic control (1), the priority valve (7) in the corresponding hydraulic connection (4) or the priority valves (7) in the corresponding hydraulic connections (4) is/are arranged in each case between the corresponding hydraulic pressure source (2) and the associated main control valve (6).
